(19) United States
(12) Patent Application Publication
(10) Pub. No.: US 2023/0035698 A1
(43) Pub. Date: Feb. 2, 2023

(54) APPARATUS, SYSTEM, AND METHOD OF WIRELESS COMMUNICATION BASED ON A NETWORK CODING (NC) SCHEME

(71) Applicants: Minyoung Park, San Ramon, CA (US); Wei Mao, San Jose, CA (US); Dave Cavalcanti, Portland, OR (US); Javier Perez-Ramirez, North Plains, OR (US); Hosein Nikopour, San Jose, CA (US)

(72) Inventors: Minyoung Park, San Ramon, CA (US); Wei Mao, San Jose, CA (US); Dave Cavalcanti, Portland, OR (US); Javier Perez-Ramirez, North Plains, OR (US); Hosein Nikopour, San Jose, CA (US)

(21) Appl. No.: 17/956,958

(22) Filed: Sep. 30, 2022

(51) Int. Cl. H04W 74/08; H04L 1/00

(52) U.S. Cl. CPC H04W 74/0816; H04L 1/0009; H04L 1/0014

(57) ABSTRACT

In one example, a transmitter wireless communication device may be configured to encode k data packets into n encoded packets according to a Network Coding (NC) scheme, wherein k is equal to or greater than two, and wherein n is greater than k. For example, the transmitter wireless communication device may be configured to transmit the n encoded packets over a plurality of wireless communication resources, for example, by transmitting at least one first encoded packet over a first wireless communication resource and transmitting at least one second encoded packet over a second wireless communication resource. For example, a receiver wireless communication device may be configured to determine the k data packets, for example, by decoding at least k received encoded packets out of the n encoded packets according to the NC scheme.

### TECHNICAL FIELD

Aspects described herein generally relate to wireless communication based on a Network Coding (NC) scheme.

### BACKGROUND

Some wireless communication networks may provide high-throughput data for users of wireless communication devices.

There is a need for technical solutions to provide increased and/or efficient access to the wireless communication medium.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of an Extremely High Throughput (EHT) Physical layer (PHY) Protocol Data Unit (PPDU) format, which may be implemented in accordance with some demonstrative aspects.

FIG. 3 is a schematic illustration of a Network Coding (NC) scheme, in accordance with some demonstrative aspects.

FIG. 4 is a schematic illustration of wireless communication according to an NC scheme, in accordance with some demonstrative aspects.

FIG. 5 is a schematic flow-chart illustration of a method of wireless communication based on an NC scheme, in accordance with some demonstrative aspects.

FIG. 6 is a schematic flow-chart illustration of a method of wireless communication based on an NC scheme, in accordance with some demonstrative aspects.

FIG. 7 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D2.0 Draft Standard for Information technology— Telecommunications and information exchange between systems Local and metropolitan area networks— Specific requirements; Part 11: Wireless LAN Medium Access Control (MAC) and Physical Layer (PHY) Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects may be implemented by an Extremely High Throughput (EHT) STA, which may include for example, a STA having a radio transmitter, which is capable of operating on a channel that is in frequency bands between 1 GHz and 7.250 Ghz. The EHT STA may perform other additional or alternative functionality. Other aspects may be implemented by any other apparatus, device and/or station.

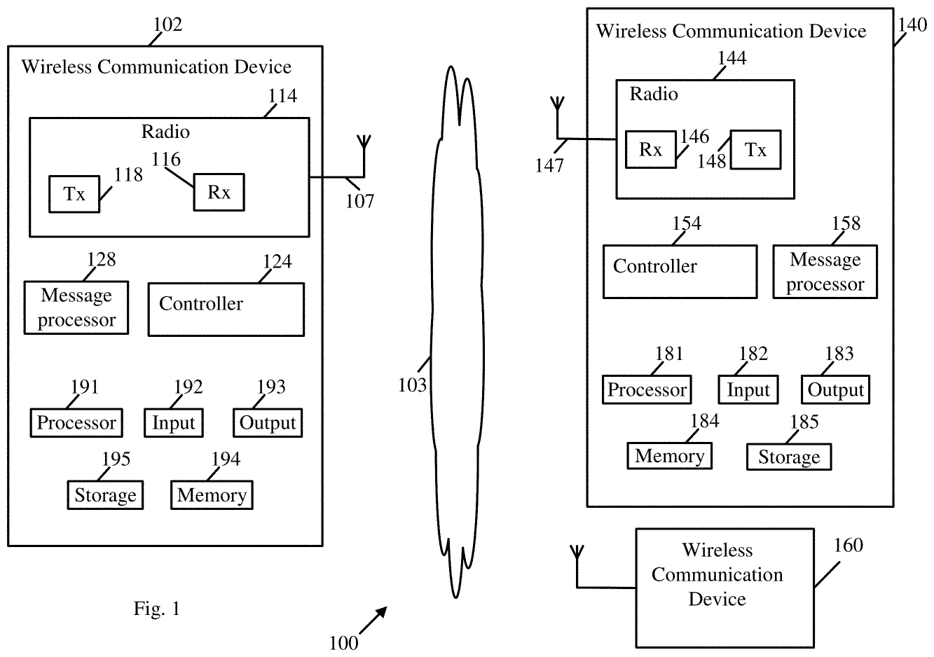

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a Smartphone, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a television, a music player, a smart device such as, for example, lamps, climate control, car components, household components, appliances, and the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, a cellular channel, an RF channel, a Wi-Fi channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include at least one radio 114, and/or device 140 may include at least one radio 144.

In some demonstrative aspects, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, radio 114 and/or radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, a mmWave band, and/or any other band, for example, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a single antenna or a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a single antenna, a plurality of antennas, a phased array antenna, a multiple element antenna, a set of switched beam antennas, and/or the like. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, antennas 107 and/or antennas 147 may be connected to, and/or associated with, one or more Radio Frequency (RF) chains.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other aspects, controller 154, message processor 158 and/or radio 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more EHT STAs. For example, device 102 may include, operate as, perform the role of, and/or perform one or more functionalities of, at least one EHT STA; device 140 may include, operate as, perform the role of, and/or perform one or more functionalities of, at least one EHT STA; and/or device 160 may include, operate as, perform the role of, and/or perform one or more functionalities of, at least one EHT STA.

In other aspects, devices 102, 140 and/or 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an access point (AP), e.g., an EHT AP, or any other AP.

In some demonstrative aspects, device 102, device 140, and/or device 160 may be configured to operate as, perform the role of, and/or perform one or more functionalities of, a non-AP STA, e.g., an EHT non-AP STA, or any other non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects devices 102, 140 and/or 160 may be configured to communicate over an EHT network, and/or any other network. For example, devices 102, 140 and/or 160 may perform Multiple-Input-Multiple-Output (MIMO) communication, for example, for communicating over the EHT networks, e.g., over an EHT frequency band, e.g., in frequency bands between 1 GHz and 7.250 GHz.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, devices 102, 140 and/or 160 may be configured according to one or more standards, for example, in accordance with an IEEE 802.11be Standard, which may be configured, for example, to enhance the efficiency and/or performance of an IEEE 802.11 Specification, which may be configured to provide Wi-Fi connectivity.

Some demonstrative aspects may enable, for example, to significantly increase the data throughput defined in the IEEE 802.11-2020 Specification, for example, up to a throughput of 30 Giga bits per second (Gbps), or to any other throughput, which may, for example, satisfy growing demand in network capacity for new coming applications.

Some demonstrative aspects may be implemented, for example, to support increasing a transmission data rate, for example, by applying MIMO and/or Orthogonal Frequency Division Multiple Access (OFDMA) techniques.

In some demonstrative aspects, devices 102, 140 and/or 160 may be configured to communicate MIMO communications and/or OFDMA communication in frequency bands between 1 GHz and 7.250 GHz.

In some demonstrative aspects, device 102, device 140 and/or device 160 may be configured to support one or more mechanisms and/or features, for example, OFDMA, Single User (SU) MIMO, and/or Multi-User (MU) MIMO, for example, in accordance with an IEEE 802.11be Standard and/or any other standard and/or protocol.

In some demonstrative aspects, device 102, device 140 and/or device 160 may include, operate as, perform a role of, and/or perform the functionality of, one or more EHT STAs. For example, device 102 may include, operate as, perform a role of, and/or perform the functionality of, at least one EHT STA, device 140 may include, operate as, perform a role of, and/or perform the functionality of, at least one EHT STA, and/or device 160 may include, operate as, perform a role of, and/or perform the functionality of, at least one EHT STA.

In some demonstrative aspects, devices 102, 140 and/or 160 may implement a communication scheme, which may include Physical layer (PHY) and/or Media Access Control (MAC) layer schemes, for example, to support one or more applications, and/or increased throughput, e.g., throughputs up to 30 Gbps, or any other throughput.

In some demonstrative aspects, the PHY and/or MAC layer schemes may be configured to support OFDMA techniques, SU MIMO techniques, and/or MU MIMO techniques.

In some demonstrative aspects, devices 102, 140 and/or 160 may be configured to implement one or more mechanisms, which may be configured to enable SU and/or MU communication of Downlink (DL) and/or Uplink frames (UL) using a MIMO scheme.

In some demonstrative aspects, device 102, device 140 and/or device 160 may be configured to implement one or more MU communication mechanisms. For example, devices 102, 140 and/or 160 may be configured to implement one or more MU mechanisms, which may be configured to enable MU communication of DL frames using a MIMO scheme, for example, between a device, e.g., device 102, and a plurality of devices, e.g., including device 140, device 160, and/or one or more other devices.

In some demonstrative aspects, devices 102, 140, and/or 160 may be configured to communicate over an EHT network, and/or any other network and/or any other frequency band. For example, devices 102, 140, and/or 160 may be configured to communicate DL transmissions and/or UL transmissions, for example, for communicating over the EHT networks.

In some demonstrative aspects, devices 102, 140 and/or 160 may be configured to communicate over a channel bandwidth, e.g., of at least 20 Megahertz (MHz), in frequency bands between 1 GHz and 7.250 GHz.

In some demonstrative aspects, devices 102, 140 and/or 160 may be configured to implement one or more mechanisms, which may, for example, support communication over a wide channel bandwidth (BW) (“channel width”) (also referred to as a “wide channel” or “wide BW”) covering two or more channels, e.g., two or more 20 MHz channels, e.g., as described below.

In some demonstrative aspects, wide channel mechanisms may include, for example, a mechanism and/or an operation whereby two or more channels, e.g., 20 MHz channels, can be combined, aggregated or bonded, e.g., for a higher bandwidth of packet transmission, for example, to enable achieving higher throughputs, e.g., when compared to transmissions over a single channel. Some demonstrative aspects are described herein with respect to communication over a channel BW including two or more 20 MHz channels, however other aspects may be implemented with respect to communications over a channel bandwidth, e.g., a “wide” channel, including or formed by any other number of two or more channels, for example, a bonded or aggregated channel including a bonding or an aggregation of two or more channels.

In some demonstrative aspects, device 102, device 140 and/or device 160 may be configured to communicate one or more transmissions over one or more channel BWs, for example, including a channel BW of 20 MHz, a channel BW of 40 MHz, a channel BW of 80 MHz, a channel BW of 160 MHz, a channel BW of 320 MHz, and/or any other additional or alternative channel BW, e.g., as described below.

In some demonstrative aspects, devices 102, 140 and/or 160 may be configured to generate, process, transmit and/or receive a Physical Layer (PHY) Protocol Data Unit (PPDU) having a PPDU format (also referred to as “EHT PPDU format”), which may be configured, for example, for communication between EHT stations, e.g., as described below.

In some demonstrative aspects, a PPDU, e.g., an EHT PPDU, may include at least one non-EHT field, e.g., a legacy field, which may be identified, decodable, and/or processed by one or more devices (“non-EHT devices”, or “legacy devices”), which may not support one or more features and/or mechanisms (“non-legacy” mechanisms or “non-EHT mechanisms”). For example, the legacy devices may include non-EHT stations and/or non-High Throughput (HT) stations, which may be, for example, configured according to an IEEE 802.11-2020 Standard, and the like.

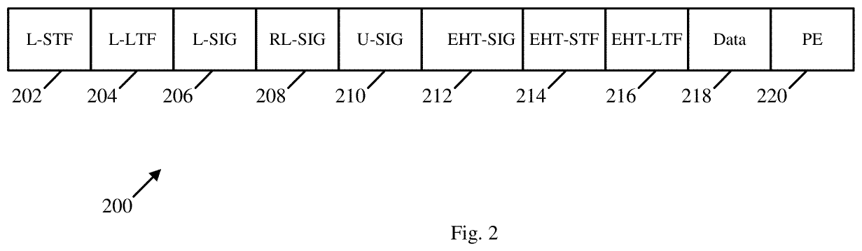

Reference is made to FIG. 2, which schematically illustrates an EHT PPDU format 200, which may be implemented in accordance with some demonstrative aspects. In one example, devices 102 (FIG. 1), 140 (FIG. 1), and/or 160 (FIG. 1) may be configured to generate, transmit, receive and/or process one or more EHT PPDUs having the structure and/or format of EHT PPDU 200.

In one example, devices 102 (FIG. 1), 140 (FIG. 1), and/or 160 (FIG. 1) may communicate EHT PPDU 200, for example, as part of a transmission over a channel, e.g., an EHT channel, having a channel bandwidth including one or more 20 MHz channels, for example, a channel BW of 20 MHz, a channel BW of 40 MHz, a channel BW of 80 MHz, a channel BW of 160 MHz, a channel BW of 320 MHz, and/or any other additional or alternative channel BW, e.g., as described below.

In some demonstrative aspects, EHT PPDU 200 may include an EHT SU PPDU, which may be utilized for transmission from an EHT STA, e.g., an EHT STA implemented by device 102 (FIG. 1), to one another STA, e.g., an EHT STA implemented by device 140 (FIG. 1).

In some demonstrative aspects, EHT PPDU 200 may include an EHT MU PPDU, which may be utilized for transmission from an EHT STA, e.g., an EHT STA implemented by device 102 (FIG. 1), to one or more users, for example, one or more EHT STAs, including an EHT STA implemented by device 140 (FIG. 1) and/or an EHT STA implemented by device 140 (FIG. 1).

In some demonstrative aspects, as shown in FIG. 2, EHT PPDU 200 may include a non-High Throughput (non-HT) (legacy) Short Training Field (STF) (L-STF) 202, followed by a non-HT (Legacy) Long Training Field (LTF) (L-LTF) 204, which may be followed by a non-HT Signal (SIG) (L-SIG) field 206.

In some demonstrative aspects, as shown in FIG. 2, EHT PPDU 200 may include a repeated non-HT SIG (RL-SIG) field 208, which may follow the L-SIG field 206. The RL-SIG field 208 may be followed by a Universal SIG (U-SIG) field 210.

In some demonstrative aspects, as shown in FIG. 2, EHT PPDU 200 may include a plurality of EHT-modulated fields, e.g., following the U-SIG field 210.

In some demonstrative aspects, as shown in FIG. 2, the EHT modulated fields may include, for example, an EHT Signal (EHT-SIG) field 212.

In some demonstrative aspects, as shown in FIG. 2, the EHT modulated fields may include, for example, an EHT STF (EHT-STF) field 214, e.g., following the EHT-SIG field 212.

In some demonstrative aspects, as shown in FIG. 2, the EHT modulated fields may include, for example, an EHT LTF (EHT-LTF) field 216, e.g., following the EHT-STF field 214.

In some demonstrative aspects, as shown in FIG. 2, the EHT modulated fields may include, for example, a data field 218, e.g., following the EHT-LTF field 216, and/or a Packet Extension (PE) field 220, e.g., following the data field 218.

In some demonstrative aspects, EHT PPDU 200 may include some or all of the fields shown in FIG. 2 and/or one or more other additional or alternative fields.

Referring back to FIG. 1, in some demonstrative aspects, devices 102, 140, and/or 160 may be configured to generate, transmit, receive and/or process one or more transmissions, e.g., including one or more EHT PPDUs, e.g., as described below.

In some demonstrative aspects, for example, devices 102, 140, and/or 160 may be configured to perform one or more operations, and/or functionalities of an EHT STA, which may be configured, for example, to generate, transmit, receive and/or process one or more transmissions, e.g., including one or more EHT PPDUs, e.g., including one or more fields according to the EHT PPDU format of FIG. 2.

In some demonstrative aspects, devices 102, 140, and/or 160 may be configured to generate, transmit, receive and/or process an EHT PPDU, e.g., in accordance with an IEEE 802.11be Specification and/or any other specification, e.g., as described below.

In some demonstrative aspects, for example, devices 102, 140, and/or 160 may be configured to perform one or more operations, and/or functionalities of an EHT STA, which may be configured, for example, to generate, transmit, receive and/or process the EHT PPDU as an EHT MU PPDU, for example, in accordance with the EHT PPDU formal 200 (FIG. 2).

In some demonstrative aspects, the EHT MU PPDU may include a PPDU that carries one or more PHY service data units (PSDUs) for one or more STAs using a downlink multi-user multiple input, multiple output (DL-MU-MIMO) technique, an orthogonal frequency division multiple access (DL OFDMA) technique, or a combination of the two techniques.

In some demonstrative aspects, for example, devices 102, 140 and/or 160 may be configured to perform one or more operations, and/or functionalities of an EHT STA, which may be configured, for example, to generate, transmit, receive and/or process the EHT MU PPDU, for example, over a 20 MHz channel width, a 40 MHz channel width, a 80 MHz channel width, a 160 MHz channel width, and/or a 320 Mhz channel width.

In other aspects, any other additional or alternative channel width may be utilized.

In some demonstrative aspects, devices 102, 140 and/or 160 may be configured to implement a low-latency wireless communication mechanism, which may be configured to provide a technical solution to support low-latency transmissions, e.g., very-low latency or ultra-low latency transmissions, in a wireless communication network, for example, a Wi-Fi network, e.g., as described below.

In some demonstrative aspects, the low-latency wireless communication mechanism may be configured to provide a technical solution to support emerging time-sensitive wireless communications, e.g., as described below.

In some demonstrative aspects, devices 102, 140 and/or 160 may be configured to implement a low-latency wireless communication mechanism, which may be configured to provide a technical solution to support an efficient way to deliver a packet with very high reliability and/or with low latency, e.g., as described below.

In some demonstrative aspects, devices 102, 140 and/or 160 may include an Ultra-Low-Latency (ULL) STA, which may be configured to communicate low-latency transmissions, e.g., as described below.

In one example, the ULL STA may be configured to support enhanced reliability and/or reduced latency, for example, to support wireless-based applications, such as Augmented Reality (AR) application, Virtual Reality (VR) applications, and/or any other applications, which may require ultra-low latency and/or very high reliability.

In some demonstrative aspects, there may be a need to provide a technical solution to support wireless communication of packets with a high level of reliability and/or a low latency.

For example, an increasing number of more wireless-based applications may require high reliability and/or low latency. However, some wireless communication technologies, e.g., Wi-Fi technologies, may be configured to operate in an unlicensed spectrum and/or in an unmanaged network environment, where interference from adjacent networks may cause packet losses.

For example, in order to avoid such interference, some wireless communication technologies, e.g., in accordance with IEEE 802.11 Specifications, may require that a wireless device utilize a Clear Channel Assessment (CCA) mechanism to assess whether a wireless medium is idle prior to a transmission, and may allow the wireless device to transmit a packet when the wireless medium is determined to be idle. For example, the CCA mechanism may require the transmitter device to wait for a period of Distributed Coordination Function (DCF) Inter-frame Space (DISF) followed by a random backoff, e.g., prior to performing a data transmission. Accordingly, the CCA mechanism may add latency, e.g., a latency of abut ˜100 microseconds (usec), to the packet delivery.

For example, in many use cases and/or scenarios, a transmitter may assess that the wireless medium is idle and transmit a data packet to an intended receiver, for example, although the wireless medium may actually be busy at the receiver side, e.g., due to a hidden node problem. This scenario may result in a packet drop at the receiver.

For example, the hidden node problem may be addressed by using a virtual carrier sensing mechanism, which may implement an exchange of Request to Send (RTS) and Clear to Send (CTS) frames, prior to a data transmission. For example, a data frame may be transmitted when the RTS/CTS exchange is successful. However, this virtual carrier sensing mechanism may add additional latency to the data delivery.

In some demonstrative aspects, vices 102, 140 and/or 160 may be configured to communicate wireless transmissions according to a wireless communication technique, which may be configured to provide a technical solution to successfully deliver k packets, e.g., equal-sized data packets, to a receiver over a Wi-Fi link, e.g., while using a reduced amount, e.g., a minimal amount, of radio resources, e.g., as described below.

In some demonstrative aspects, devices 102, 140 and/or 160 may be configured to communicate wireless transmissions based on a Network Coding (NC) scheme, e.g., as described below.

In some demonstrative aspects, the NC scheme may include a linear packet-level coding scheme, e.g., as described below. In other aspects, any other NC scheme may be implemented.

In some demonstrative aspects, the NC scheme may be based on linear packet erasure codes.

In some demonstrative aspects, the NC scheme may be based on forward error correction codes.

In other aspects, the NC scheme may be based on any other type of codes, which may be configured for network coding.

In some demonstrative aspects, devices 102, 140 and/or 160 may be configured to communicate wireless transmissions based on the NC scheme, for example, to provide a technical solution to support low-latency and/or high-reliability data traffic, e.g., as described below.

In some demonstrative aspects, the NC scheme may be configured to combine, e.g., to linearly combine, data packets, for example, to form new encoded packets having dependence among them, e.g., as described below.

In some demonstrative aspects, wireless transmissions according to the NC scheme may be implemented provide a technical solution to support recovery of the original data packets, for example, even in case only some of the encoded packets are successfully received. For example, as long as a sufficient number of encoded packets, e.g., regardless of which ones, are correctly received at the receiver, the original data packets may be recovered, for example, despite possible losses of all other encoded packets.

In some demonstrative aspects, wireless transmissions according to the NC scheme may be implemented to provide a technical solution to proactively add redundancy to the traffic and/or to significantly reduce latency, e.g., compared to repetition schemes.

In some demonstrative aspects, wireless transmissions according to the NC scheme may be implemented to provide a technical solution, which is much more spectrally efficient, e.g., compared to packet repetition techniques, for example, while not requiring too much additional computational complexity for encoding and decoding.

In some demonstrative aspects, devices 102, 140 and/or 160 may be configured to communicate wireless transmissions based on the NC scheme, which may be configured to encode a plurality of data packets, e.g., including k data packets, into a plurality of encoded packets, e.g., including n>k encoded packets, e.g., as described below.

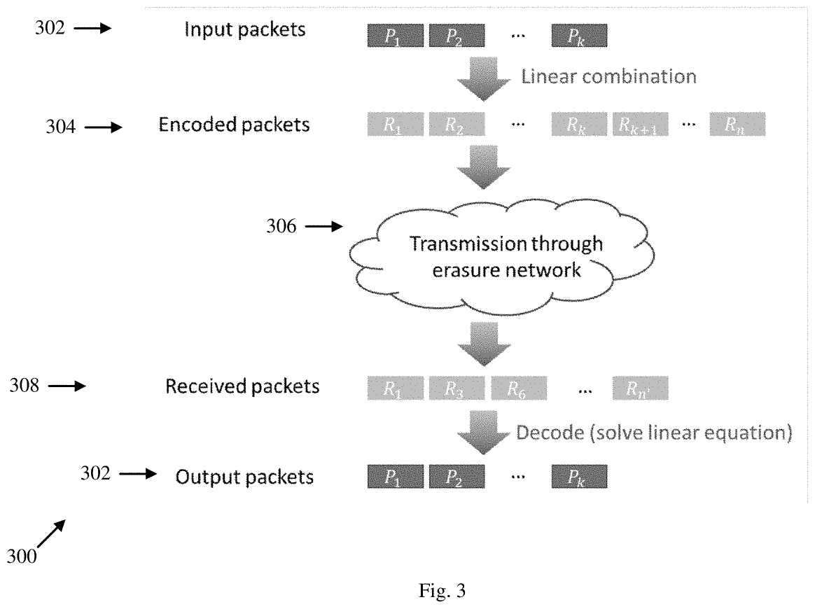

Reference is made to FIG. 3, which schematically illustrates an NC scheme 300, in accordance with some demonstrative aspects. For example, devices 102, 140 and/or 160 may be configured to communicate wireless transmissions based on the NC scheme 300.

For example, the NC scheme 300 may be based on a linear packet-level coding, e.g., as described below.

For example, as shown in FIG. 3, a set of n coded packets 304, denoted [R₁, R₂, . . . , Rₙ], may be determined by encoding a set of k packets 302, e.g., k same-sized packets, denoted [P₁, P₂, . . . , Pₖ], which may be viewed as column vectors over a finite field, e.g., a Galois Field [symbol] .

For example, a linearly coded packet may be constructed as R=Σᵢ₌₁^{k}cᵢ. Pᵢ, for example, based on an encoding vector [c₁, c₂ . . . , cₖ]^{T}, which may include coefficients chosen from the Field [symbol] .

For example, the set of n coded packets 304 may be determined, e.g., as follows:

Rⱼ=Σᵢ₌₁^{k}cᵢⱼPᵢ,cᵢⱼ∈

[symbol]

[R₁,R₂, . . . ,Rₙ]=[P₁,P₂, . . . ,Pₖ][cᵢⱼ]_{k×n}

For example, as shown in FIG. 3, the set of n coded packets 304 may be transmitted through a lossy channel/network 306, where packets may be dropped (erasure). For example, packet lose may correspond to deletion of columns of [cᵢⱼ].

For example, as shown in FIG. 3, the NC scheme 300 may be configured to generate the set of n coded packets 304, for example, such that a receiver may still be able to recover the original packets [P₁, P₂, . . . , Pₖ], for example, even if the receiver receives only k received encoded packets 308, denoted [R₁, R₂, . . . , Rₖ], of the n network coded packets that are linearly independent. For example, the receiver may recover the original packets [P₁, P₂, . . . , Pₖ] by determining [R₁ R₂ . . . Rₖ]M⁻¹, wherein:

$$M = [ \begin{matrix}{c}_{1}^{1} & {c}_{1}^{2} & … & {c}_{1}^{k} \\ {c}_{2}^{1} & {c}_{2}^{2} & … & {c}_{2}^{k} \\ ⋮ & ⋮ & … & ⋮ \\ {c}_{k}^{1} & {c}_{k}^{2} & … & {c}_{k}^{k}\end{matrix} ]$$

wherein the i-th column of the matrix M may include the encoding vector for Rᵢ.

For example, the NC scheme 300 may be implemented to provide a technical solution to support an improved rate-reliability trade-off, e.g., compared to repetition techniques. For example, the improvement of the rate-reliability trade-off may increase with an increase in the coding group size (k).

For example, coding coefficients of the NC scheme 300, e.g., the coefficients cₖ may be chosen, for example, from codes with good performances, e.g., with a Maximum Distance Separable (MDS) property, for example, such that any choices of k encoding vectors may be linearly independent. In other aspects, any other coefficients may be implemented according to any other performance properties.

Referring back to FIG. 1, in some demonstrative aspects, controller 124 may be configured to control, trigger, cause, and/or instruct device 102 to encode a plurality of data packets, for example, a stream of data packets, e.g., including k data packets, into a plurality of encoded packets, for example, a stream of encoded packets, e.g., including n encoded packets, according to an NC scheme, e.g., as described below.

In some demonstrative aspects, the count k of packets in the plurality of data packets may be equal to or greater than two, and the count n of encoded packets in the plurality of encoded packets may be greater than k, e.g., as described below.

In some demonstrative aspects, the NC scheme may be configured, for example, such that the k data packets may be decodable from a group of encoded packets including at least k encoded packets of the n encoded packets.

In some demonstrative aspects, the NC scheme may be configured, for example, such that the k data packets may be decodable from any group of p encoded packets from the n encoded packets, wherein p is a predefined value equal to or greater than k.

In some demonstrative aspects, the NC scheme may be configured, for example, such that the k data packets may be decodable from any group of k encoded packets from the n encoded packets.

In some demonstrative aspects, the k data packets may include time-sensitive data packets, e.g., as described below.

In other aspects, the k data packets may include any other additional or alternative type of packets.

In some demonstrative aspects, controller 124 may be configured to control, trigger, cause, and/or instruct device 102 to transmit the n encoded packets over a plurality of wireless communication resources, e.g., as described below.

In some demonstrative aspects, controller 124 may be configured to control, trigger, cause, and/or instruct device 102 to transmit the n encoded packets over the plurality of wireless communication resources, for example, by transmitting at least one first encoded packet over a first wireless communication resource, and transmitting at least one second encoded packet over a second wireless communication resource, e.g., as described below.

In some demonstrative aspects, controller 124 may be configured to control, trigger, cause, and/or instruct radio 114 to transmit the n encoded packets over the plurality of wireless communication resources.

In some demonstrative aspects, the plurality of wireless communication resources may include a plurality of wireless communication frequency resources, e.g., as described below.

In some demonstrative aspects, the plurality of wireless communication resources may include a plurality of wireless communication channels, e.g., as described below.

In some demonstrative aspects, a wireless communication channel of the plurality of wireless communication channels may include a channel width of at least 20 MHz, e.g., as described below. In other aspects, any other channel width may be implemented.

In some demonstrative aspects, the plurality of wireless communication resources may include a plurality of Orthogonal-Frequency-Division-Multiple-Access (OFDMA) Resource Units (RUs), e.g., as described below.

In some demonstrative aspects, the plurality of wireless communication resources may include a plurality of wireless communication links between the wireless communication device 102 and a receiver device, for example, device 140 and/or device 160, e.g., as described below.

In other aspects, the plurality of wireless communication resources may include any other additional or alternative resources.

In some demonstrative aspects, controller 124 may be configured to control, trigger, cause, and/or instruct device 102 to avoid fully performing a Carrier Sense Multiple Access/Collision Avoidance (CSMA/CA) procedure prior to transmitting the n encoded packets over the plurality of wireless communication resources, e.g., as described below.

In some demonstrative aspects, controller 124 may be configured to control, trigger, cause, and/or instruct device 102 to mandate the wireless communication device to fully perform the CSMA/CA procedure prior to transmitting one or more other data packets, which are not encoded according to the NC scheme, over one or more of the wireless communication resources.

In some demonstrative aspects, the k data packets, which are encoded according to the NC scheme, may have a first latency requirement, e.g., a relatively low latency requirement. Accordingly, controller 124 may cause device 102 to avoid fully performing the CSMA/CA procedure prior to transmitting the n encoded packets, e.g., in order to support communication of the n encoded packets with relatively low latency.

In some demonstrative aspects, the other data packets, e.g., packets for which the CSMA/CA procedure is mandated, may have a second latency requirement, e.g., a non-urgent latency requirement.

For example, the first latency requirement may be lower than the second latency requirement.

In some demonstrative aspects, controller 124 may be configured to control, trigger, cause, and/or instruct device 102 to select whether to communicate data packets according to the NC scheme, for example, based on a latency requirement for communication of the data packets.

For example, controller 124 may be configured to control, trigger, cause, and/or instruct device 102 to select to communicate the data packets according to the NC scheme, for example, when the data packets include packets, e.g., urgent packets, which are to be communicated with low latency.

For example, controller 124 may be configured to control, trigger, cause, and/or instruct device 102 to avoid fully performing the CSMA/CA procedure prior to transmitting the data packets according to the NC scheme, e.g., in order to avoid a latency incurred by the CSMA/CA mechanism.

For example, controller 124 may be configured to control, trigger, cause, and/or instruct device 102 to select to communicate the data packets according to a scheme other than the NC scheme, e.g., a repetition-based scheme, for example, when the data packets include packets, e.g., non-urgent packets, which do not have a low latency requirement.

For example, controller 124 may be configured to control, trigger, cause, and/or instruct device 102 to fully perform the CSMA/CA procedure prior to transmitting the data packets, for example, when the data packets include packets, e.g., non-urgent packets, which do not have a low latency requirement.

In some demonstrative aspects, fully performing the CSMA/CA procedure may include, for example, performing of a full CCA and backoff procedure, e.g., in accordance with an IEEE 802.11 Specification.

In some demonstrative aspects, fully performing the CSMA/CA procedure may include, for example, performing a virtual carrier sensing procedure, for example, using an RTS/CTS exchange, e.g., in accordance with an IEEE 802.11 Specification.

In some demonstrative aspects, controller 124 may be configured to control, trigger, cause, and/or instruct device 102 to avoid fully performing the CSMA/CA procedure, for example, by avoiding performance of a full CCA and backoff procedure, for example, prior to transmitting the n encoded packets over the plurality of wireless communication resources, e.g., as described below.

In some demonstrative aspects, controller 124 may be configured to control, trigger, cause, and/or instruct device 102 to avoid fully performing the CSMA/CA procedure, for example, by avoiding performance of a virtual carrier sensing procedure, for example, prior to transmitting the n encoded packets over the plurality of wireless communication resources, e.g., as described below.

In some demonstrative aspects, controller 124 may be configured to control, trigger, cause, and/or instruct device 102 to generate the n encoded packets to include packet-order information to indicate to a receiver an order of the n encoded packets. For example, this packet-order information may be implemented to provide a technical solution to support the receiver in decoding the received packets, e.g., as described below.

In some demonstrative aspects, controller 124 may be configured to control, trigger, cause, and/or instruct device 102 to generate the n encoded packets, for example, by including in an encoded packet of the n encoded packets a sequence number, which may be configured to indicate a location of the encoded packet in the n encoded packets, e.g., as described below.

In other aspects, any other additional or alternative packet-order information may be utilized.

In some demonstrative aspects, controller 124 may be configured to control, trigger, cause, and/or instruct device 102 to transit the n encoded packets, for example, to communicate the k data packets to one or more receivers (destinations), for example, device 140 and/or device 160.

In some demonstrative aspects, controller 154 may be configured to control, trigger, cause, and/or instruct device 140 to process a plurality of received packets from a transmitter device, e.g., device 102.

In some demonstrative aspects, the plurality of received packets may include at least k encoded packets out of n encoded packets. For example, the n encoded packets may encode k data packets according to an NC scheme, for example, wherein k is equal to or greater than two, and wherein n is greater than k, e.g., as described above.

For example, the plurality of received packets may include at least k encoded packets out of the n encoded packets transmitted by device 102, for example, based on the k data packets, e.g., as described above.

In some demonstrative aspects, controller 154 may be configured to control, trigger, cause, and/or instruct device 140 to determine the k data packets by decoding the at least k encoded packets according to the NC scheme, e.g., as described below.

In some demonstrative aspects, controller 154 may be configured to control, trigger, cause, and/or instruct device 140 to listen over a plurality of wireless communication resources to receive the plurality of received packets, e.g., as described below.

For example, the plurality of wireless communication resources may include some or all of the wireless communication resources used by device 102 for transmission of the n encoded packets, e.g., as described above.

In some demonstrative aspects, controller 154 may be configured to control, trigger, cause, and/or instruct device 140 to listen over a plurality of wireless communication frequency resources to receive one or more, e.g., some or all, received packets of the plurality of received packets.

In some demonstrative aspects, controller 154 may be configured to control, trigger, cause, and/or instruct device 140 to listen over a plurality of wireless communication channels to receive one or more received packets of the plurality of received packets.

In some demonstrative aspects, controller 154 may be configured to control, trigger, cause, and/or instruct device 140 to listen over a plurality of wireless communication channels to receive one or more, e.g., some or all, received packets of the plurality of received packets.

For example, the plurality of wireless communication channels may include a channel width of at least 20 MHz, e.g., as described above. In other aspects, any other channel width may be implemented.

In some demonstrative aspects, controller 154 may be configured to control, trigger, cause, and/or instruct device 140 to listen over a plurality of OFDMA RUs to receive one or more, e.g., some or all, received packets of the plurality of received packets.

In some demonstrative aspects, controller 154 may be configured to control, trigger, cause, and/or instruct device 140 to listen over a plurality of OFDMA RUs to receive one or more, e.g., some or all, received packets of the plurality of received packets.

In some demonstrative aspects, controller 154 may be configured to control, trigger, cause, and/or instruct device 140 to listen over a plurality of wireless communication links between the wireless communication device and the transmitter device, for example, to receive one or more, e.g., some or all, received packets of the plurality of received packets.

In other aspects, controller 154 may be configured to control, trigger, cause, and/or instruct device 140 to listen over any other additional or alternative wireless communication resources, for example, to receive one or more, e.g., some or all, received packets of the plurality of received packets.

In some demonstrative aspects, a transmitter device, e.g., device 102, and a receiver device, e.g., device 140, may be configured to setup, negotiate and/or coordinate the plurality wireless communication resources to be used for communicating the encoded packets according to the NC encoding scheme, e.g., as described below.

In some demonstrative aspects, a transmitter device, e.g., device 102, and a receiver device, e.g., device 140, may be configured to exchange one or more frames and/or messages, which may be configured to setup, negotiate and/or coordinate the plurality wireless communication resources to be used for communicating the encoded packets according to the NC encoding scheme, e.g., as described below.

In some demonstrative aspects, controller 124 may be configured to control, trigger, cause, and/or instruct device 102 to communicate setup information with a receiver device, e.g., device 140 and/or device 160, for example, prior to transmitting the n encoded packets to the receiver device, e.g., as described below.

In some demonstrative aspects, controller 154 may be configured to control, trigger, cause, and/or instruct device 140 to communicate setup information with the transmitter device, e.g., device 102, for example, prior to receiving the plurality of received packets according to the NC encoding scheme, e.g., as described below.

In some demonstrative aspects, the setup information may include information to identify the plurality of wireless communication resources to be used communicating the encoded packets according to the NC encoding scheme.

In one example, the setup information may include information to identify a plurality of wireless communication frequency resources to be used communicating the encoded packets according to the NC encoding scheme.

In another example, the setup information may include information to identify a plurality of wireless communication channels to be used communicating the encoded packets according to the NC encoding scheme.

In another example, the setup information may include information to identify a plurality of OFDMA RUs to be used communicating the encoded packets according to the NC encoding scheme.

In another example, the setup information may include information to identify a plurality of wireless communication links to be used communicating the encoded packets according to the NC encoding scheme.

In some demonstrative aspects, controller 124 may be configured to control, trigger, cause, and/or instruct device 102 to transmit the setup information as part of one or more advertisement messages, which may be configured to advertise the plurality wireless communication resources to be used for communicating the encoded packets according to the NC encoding scheme.

In one example, controller 124 may be configured to control, trigger, cause, and/or instruct device 102 to transmit the setup information as part of a dedicated advertisement message, which may be dedicated to advertising the plurality wireless communication resources to be used for communicating the encoded packets according to the NC encoding scheme.

In another example, controller 124 may be configured to control, trigger, cause, and/or instruct device 102 to transmit the setup information as part of an advertisement message, which may be configured to advertise additional information, e.g., capability information corresponding to one or more capabilities of the device 102, setup information corresponding to a setup of one or more transmissions, and/or any other suitable information.

In one example, controller 124 may be configured to control, trigger, cause, and/or instruct device 102 to broadcast the setup information as part of a beacon transmission.

In one example, controller 124 may be configured to control, trigger, cause, and/or instruct device 102 to include the setup information as part of a probe response, e.g., in response to a probe request from the receiver device.

In some demonstrative aspects, devices 102 and 140 may be configured to communicate the setup information as part of one or more negotiation messages, which may be configured to negotiate the plurality wireless communication resources to be used for communicating the encoded packets according to the NC encoding scheme.

In one example, controller 154 may be configured to control, trigger, cause, and/or instruct device 140 to transmit to device 102 a first message, e.g., a probe request message, a link setup message, and/or any other message, which may be configured to identify one or more receiver-supported wireless communication resources to be used for communicating the encoded packets according to the NC encoding scheme.

In one example, controller 124 may be configured to control, trigger, cause, and/or instruct device 102 to transmit to device 140 a second message, e.g., a probe response message, a link setup message, and/or any other message, which may be configured to identify one or more transmitter-supported wireless communication resources to be used for communicating the encoded packets according to the NC encoding scheme.

In some demonstrative aspects, controller 154 may be configured to control, trigger, cause, and/or instruct device 140 to identify a location of a received encoded packet in the n encoded packets, for example, based on packet-order information in the received encoded packet.

In some demonstrative aspects, controller 154 may be configured to control, trigger, cause, and/or instruct device 140 to identify a location of a received encoded packet in the n encoded packets, for example, based on a sequence number in the received encoded packet, e.g., as described above.

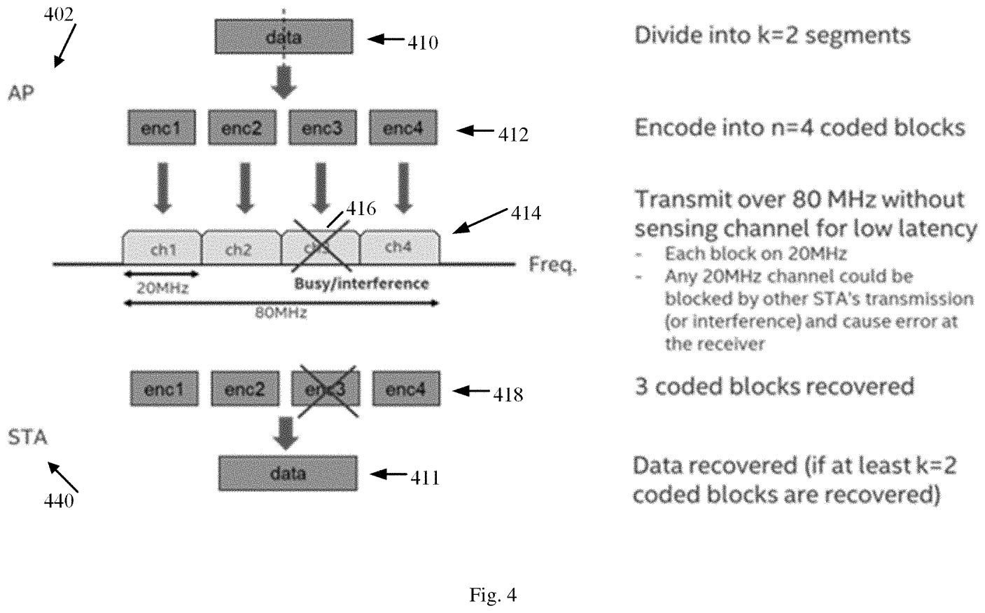

Reference is made to FIG. 4, which schematically illustrates wireless communication according to an NC scheme, in accordance with some demonstrative aspects.

In some demonstrative aspects, as shown in FIG. 4, a transmitter device 402, for example, an AP, may transmit a plurality of data packets to a receiver device 440, for example, a non-AP STA, according to an NC scheme, e.g., the NC scheme 300 (FIG. 3). For example, device 102 (FIG. 1) may perform one or more operations, one or more functionalities, the role of, and/or the functionality of, device 402; and/or device 140 (FIG. 1) may perform one or more operations, one or more functionalities, the role of, and/or the functionality of, device 440.

In some demonstrative aspects, transmitter device 402 may be configured to implement the NC scheme, e.g., NC scheme 300 (FIG. 3) to encode k data packets into n coded packets (n>k), and to transmit the n encoded packets on multiple wireless communication resources, e.g., as described above.

In some demonstrative aspects, as shown in FIG. 4, transmitter device 402 may be configured to transmit the n encoded packets on multiple 20 MHz channels and/or RUs in an OFDMA structure.

In some demonstrative aspects, the transmitter device 402 may identify there are k data packets to transmit to the receiver device 440, e.g., packets to be transmitted at a very low latency and/or high reliability.

In some demonstrative aspects, the transmitter device 402 may determine that network coding is to applied to the k data packets, for example, based on a determination that these k packets are to be transmitted at a very low latency and/or high reliability.

In some demonstrative aspects, the transmitter device 402 may apply a network coding to the k data packets to generate n encoded packets, e.g., at a code rate of k/n.

For example, the transmitter device 402 may implement a systematic code for the network coding. For example, the transmitter device 402 (e.g., an AP) may generate (n-k) parity packets, e.g., based on the k data packets, and may then transmit k data packets and the (n-k) parity packets.

In one example, as shown in FIG. 4, the transmitter device 402 may identify data 410 as data, which is to be transmitted at a very low latency and/or high reliability. For example, the transmitter device 402 may identify data 410 as data, which is to be transmitted to an ULL STA implemented by the receiver device 440.

For example, as shown in FIG. 4, the transmitter device 402 may divide the data 410 into k data segments, e.g., into k=2 data segments.

For example, as shown in FIG. 4, the transmitter device 402 may encode the k data segments into n=4 encoded blocks 412, e.g., according to a network coding scheme. For example, the encoded blocks 412 may be generated according to a code rate of 2/4=½.

In some demonstrative aspects, as shown in FIG. 4, the transmitter device 402 may transmit the n=4 encoded blocks 412 over a plurality of wireless communication resources.

For example, as shown in FIG. 4, the transmitter device 402 may transmit the n=4 encoded blocks 412 over four 20 MHz channels 414.

For example, as shown in FIG. 4, the four 20 MHz channels 414 may be part of an 80 MHz channel width.

For example, as shown in FIG. 4, the four 20 MHz channels 414 may include four contiguous 20 MHz channels in the 80 MHz channel width.

In other aspects, any other four channels 414 may be implemented, e.g., contiguous or non-contiguous channels in any other channel width, may be implemented.

For example, as shown in FIG. 4, the transmitter device 402 may transmit the n=4 encoded blocks 412 over four 20 MHz channels 414.

For example, one or more encoded packets 412 may be transmitted on each channel, e.g., 20 MHz channel, RU, and/or link.

For example, as shown in FIG. 4, the transmitter device 402 may transmit each of the n=4 encoded blocks 412 over a respective channel of the four 20 MHz channels 414.

In other aspects, any other count of channels may be used.

For example, the transmitter device 402 may transmit the n=4 encoded blocks 412 over two 20 MHz channels 414. In one example, the transmitter device 402 may transmit two encoded blocks 412 over a first 20 MHz channel, and two encoded blocks 412 over a second 20 MHz channel. In another example, the transmitter device 402 may transmit three encoded blocks 412 over a first 20 MHz channel, and one encoded block 412 over a second 20 MHz channel.

In another example, the transmitter device 402 may transmit the n=4 encoded blocks 412 over three 20 MHz channels 414. In one example, the transmitter device 402 may transmit one encoded block 412 over a first 20 MHz channel, one encoded block 412 over a second 20 MHz channel, and two encoded blocks 412 over a third 20 MHz channel.

In other aspects, any other channel width may be used. For example, the transmitter device 402 may transmit the n=4 encoded blocks 412 over two or more channels having a channel width different from 20 MHz.

In other aspects, the transmitter device 402 may transmit the n=4 encoded blocks 412 over any other frequency segments, e.g., RUs in an OFDMA structure, for example, within a single link, or across multiple links and/or bands, e.g., in a multi-link setup.

In some demonstrative aspects, the transmitter device 402 may be configured to avoid fully performing a CSMA/CA procedure prior to transmitting the n encoded bocks 412 over the four 20 MHz channels 414.

In some demonstrative aspects, the transmitter device 402 may be configured to avoid performance of a full CCA and backoff procedure prior to transmitting the n encoded bocks 412 over the four 20 MHz channels 414, e.g., as described above.

In some demonstrative aspects, the transmitter device 402 may be configured to avoid performance of a virtual carrier sensing procedure prior to transmitting the n encoded bocks 412 over the four 20 MHz channels 414, e.g., as described above.

In some demonstrative aspects, the transmitter device 402 may be configured to transmit the n=4 encoded blocks 412 over the four 20 MHz channels 414, for example, while avoiding sensing the 20 MHz channels 414, for example, in order to support low latency, by reducing, e g, minimizing, channel access delay from the overall latency.

For example, the transmitter device 402 may be configured to transmit the n=4 encoded blocks 412 over the four 20 MHz channels 414, for example, without performing a full CCA, for example, without performing a DIFS+ random backoff and/or virtual carrier sensing, e.g., an RTS/CTS exchange and/or Buffer Status Report Poll/Buffer Status Report (BSRP/BSR) exchanges, which may increase latency.

In some demonstrative aspects, one or more of the 20 MHz channels 414 may be blocked, for example, by transmissions from one or more other STAs, and/or any other interference. Accordingly, one or more of the encoded blocks 412 may not be successfully received by the receiver device 440.

For example, as shown in FIG. 4, a channel 416 may be busy and/or blocked by interference, e.g., due to interference from an adjacent network. Accordingly, an encoded block transmitted over the channel 416 may be received with error at the receiver device 440.

In some demonstrative aspects, as shown in FIG. 4, the receiver device 440 may receive a plurality of received encoded blocks 418, e.g., including only three encoded blocks 418. For example, as shown in FIG. 4, the receiver device 440 may not be able to successfully recover the encoded block transmitted over the blocked channel 416.

In some demonstrative aspects, the receiver device 440 may be configured to listen over multiple channels, e.g., the 20 MHz channels 414, multiple RUs, and/or across one or more links, e.g., when multi-link setup is used, for example, in attempt to receive the n=4 encoded blocks 412 from the transmitter device 402.

For example, the receiver device 440 may receive one or more encoded packets, e.g., on each 20 MHz channel, RU, and/or link.

For example, the receiver device 440 may reconstruct a data packet 411, e.g., the data packet 410, according to the NC scheme, for example, if at least k out of the n encoded packets 412 are received correctly.

For example, the receiver device 440 may reconstruct the data packet 411 according to the NC scheme, for example, if at least k=2 coded blocks are successfully recovered.

In some demonstrative aspects, the transmitter device 402 may be configured to transmit the encoded packets 412, for example, in a specific order in time and/or frequency. For example, order of the encoded packets 412 may be predefined, for example, based on negotiation between the transmitter device 402 and the receiver device 440, e.g., as described above.

In some demonstrative aspects, the transmitter device 402 may be configured to include in an encoded packet 412, e.g., in each packet 412, a sequence number, which may indicate the location of the encoded packet in the n encoded packets 412.

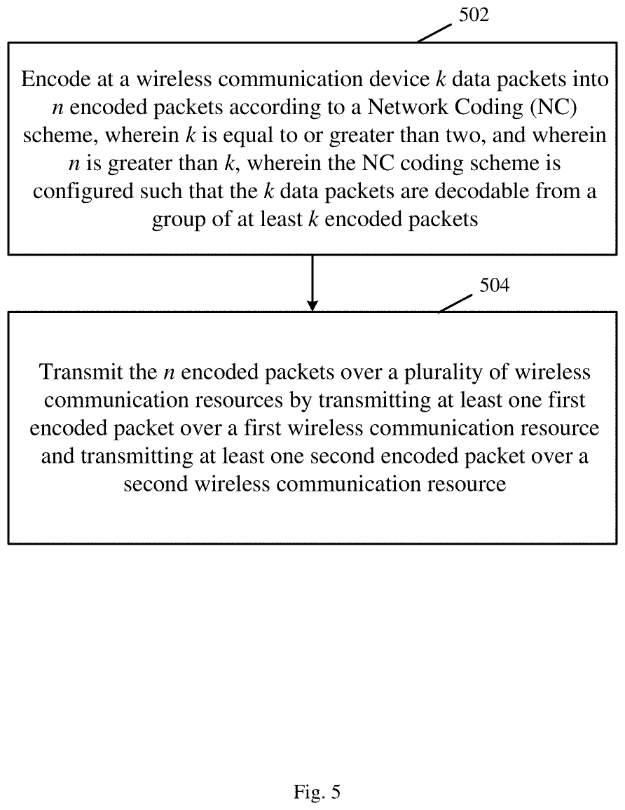

Reference is made to FIG. 5, which schematically illustrates a method of wireless communication based on an NC scheme, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include encoding at a wireless communication device k data packets into n encoded packets according to an NC scheme. For example, controller 124 (FIG. 1) may be configured to cause, trigger, and/or control device 102 (FIG. 1) to encode the k data packets into the n encoded packets according to the NC scheme, e.g., as described above.

As indicated at block 504, the method may include transmitting the n encoded packets over a plurality of wireless communication resources by transmitting at least one first encoded packet over a first wireless communication resource and transmitting at least one second encoded packet over a second wireless communication resource. For example, controller 124 (FIG. 1) may be configured to cause, trigger, and/or control device 102 (FIG. 1) to transmit the n encoded packets over the plurality of wireless communication resources, e.g., as described above.

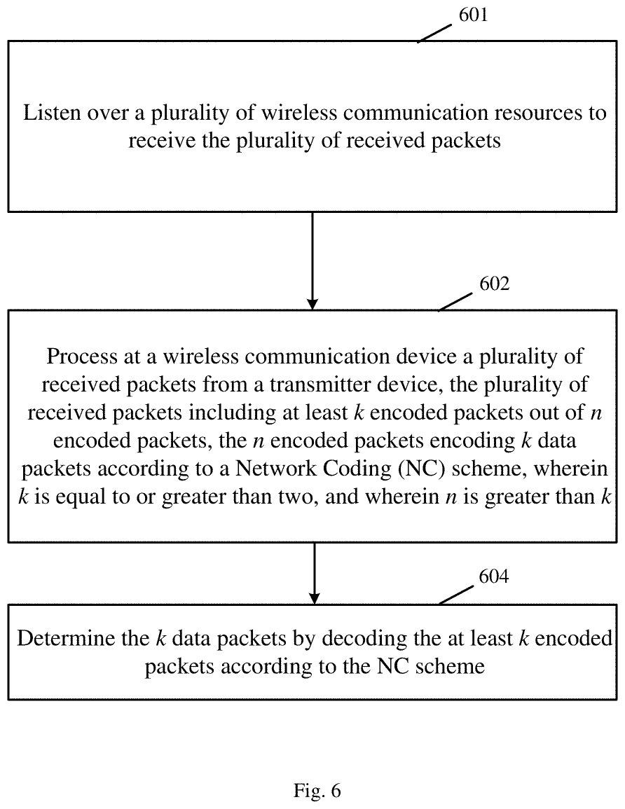

Reference is made to FIG. 6, which schematically illustrates a method of wireless communication based on an NC scheme, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include processing at a wireless communication device a plurality of received packets from a transmitter device. For example, the plurality of received packets may include at least k encoded packets out of n encoded packets, the n encoded packets encoding k data packets according to an NC scheme, e.g., wherein k is equal to or greater than two, and n is greater than k. For example, controller 154 (FIG. 1) may be configured to cause, trigger, and/or control device 140 (FIG. 1) to process plurality of received packets including the at least k encoded packets out of the n encoded packets transmitted by device 102 (FIG. 1), e.g., as described above.

As indicated at block 604, the method may include determining the k data packets, for example, by decoding the at least k encoded packets according to the NC scheme. For example, controller 154 (FIG. 1) may be configured to cause, trigger, and/or control device 140 (FIG. 1) to determine the k data packets, for example, by decoding the at least k encoded packets according to the NC scheme, e.g., as described above.

As indicated at block 601, the method may include listening over a plurality of wireless communication resources to receive the plurality of received packets. For example, controller 154 (FIG. 1) may be configured to cause, trigger, and/or control device 140 (FIG. 1) to listen over the plurality of wireless communication resources to receive the plurality of received packets from device 102 (FIG. 1), e.g., as described above.

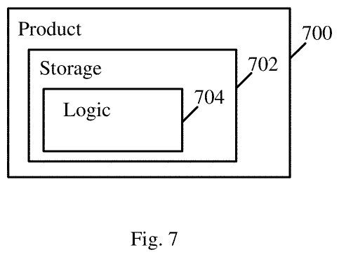

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-6, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 700 and/or machine readable storage media 702 may include one or more types of computer-readable storage media capable of storing data, including volatile memory, non-volatile memory, removable or non-removable memory, erasable or non-erasable memory, writeable or re-writeable memory, and the like. For example, machine readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to encode k data packets into n encoded packets according to a Network Coding (NC) scheme, wherein k is equal to or greater than two, and wherein n is greater than k, wherein the NC scheme is configured such that the k data packets are decodable from a group of at least k encoded packets; and transmit the n encoded packets over a plurality of wireless communication resources by transmitting at least one first encoded packet over a first wireless communication resource and transmitting at least one second encoded packet over a second wireless communication resource.

Example 2 includes the subject matter of Example 1, and optionally, wherein the apparatus is configured to cause the wireless communication device to avoid fully performing a Carrier Sense Multiple Access/Collision Avoidance (CSMA/CA) procedure prior to transmitting the n encoded packets over the plurality of wireless communication resources.

Example 3 includes the subject matter of Example 2, and optionally, wherein the apparatus is configured to mandate the wireless communication device to fully perform the CSMA/CA procedure prior to transmitting one or more other data packets, which are not encoded according to the NC scheme, over one or more of the wireless communication resources.

Example 4 includes the subject matter of Example 3, and optionally, wherein the k data packets have a first latency requirement and the other data packets have a second latency requirement, the first latency requirement is lower than the second latency requirement.

Example 5 includes the subject matter of any one of Examples 2-4, and optionally, wherein the apparatus is configured to cause the wireless communication device to avoid fully performing the CSMA/CA procedure by avoiding performance of a full Clear Channel Assessment (CCA) and backoff procedure prior to transmitting the n encoded packets over the plurality of wireless communication resources.

Example 6 includes the subject matter of any one of Examples 2-5, and optionally, wherein the apparatus is configured to cause the wireless communication device to avoid fully performing the CSMA/CA procedure by avoiding performance of a virtual carrier sensing procedure prior to transmitting the n encoded packets over the plurality of wireless communication resources.

Example 7 includes the subject matter of any one of Examples 1-6, and optionally, wherein the plurality of wireless communication resources comprises a plurality of wireless communication frequency resources.

Example 8 includes the subject matter of any one of Examples 1-7, and optionally, wherein the plurality of wireless communication resources comprises a plurality of wireless communication channels.

Example 9 includes the subject matter of Example 8, and optionally, wherein a wireless communication channel of the plurality of wireless communication channels comprises a channel width of at least 20 Megahertz (MHz).

Example 10 includes the subject matter of any one of Examples 1-9, and optionally, wherein the plurality of wireless communication resources comprises a plurality of Orthogonal-Frequency-Division-Multiple-Access (OFDMA) Resource Units (RUs).

Example 11 includes the subject matter of any one of Examples 1-10, and optionally, wherein the plurality of wireless communication resources comprises a plurality of wireless communication links between the wireless communication device and a receiver device.

Example 12 includes the subject matter of any one of Examples 1-11, and optionally, wherein an encoded packet of the n encoded packets comprises a sequence number to indicate a location of the encoded packet in the n encoded packets.

Example 13 includes the subject matter of any one of Examples 1-12, and optionally, wherein the NC scheme is configured such that the k data packets are decodable from any group of p encoded packets from the n encoded packets, wherein p is a predefined value equal to or greater than k.

Example 14 includes the subject matter of any one of Examples 1-13, and optionally, wherein the NC scheme is configured such that the k data packets are decodable from any group of k encoded packets from the n encoded packets.

Example 15 includes the subject matter of any one of Examples 1-14, and optionally, wherein the k data packets comprise time-sensitive data packets.

Example 16 includes the subject matter of any one of Examples 1-15, and optionally, wherein the apparatus is configured to cause the wireless communication device to communicate setup information with a receiver device prior to transmitting the n encoded packets to the receiver device, wherein the setup information comprises information to identify the plurality of wireless communication resources.

Example 17 includes the subject matter of any one of Examples 1-16, and optionally, wherein the wireless communication device comprises an Ultra-Low-Latency (ULL) STA.

Example 18 includes the subject matter of any one of Examples 1-17, and optionally, comprising a radio to transmit the n encoded packets.

Example 19 includes the subject matter of Example 18, and optionally, comprising one or more antennas connected to the radio, and a processor to execute instructions of an operating system of the wireless communication device.

Examples 20 includes an apparatus comprising logic and circuitry configured to cause a wireless communication device to process a plurality of received packets from a transmitter device, the plurality of received packets comprising at least k encoded packets out of n encoded packets, the n encoded packets encoding k data packets according to a Network Coding (NC) scheme, wherein k is equal to or greater than two, and wherein n is greater than k; and determine the k data packets by decoding the at least k encoded packets according to the NC scheme.

Example 21 includes the subject matter of Example 20, and optionally, wherein the apparatus is configured to cause the wireless communication device to listen over a plurality of wireless communication resources to receive the plurality of received packets.

Example 22 includes the subject matter of Example 21, and optionally, wherein the plurality of wireless communication resources comprises a plurality of wireless communication frequency resources.

Example 23 includes the subject matter of any one of Example 21 or 22, and optionally, wherein the plurality of wireless communication resources comprises a plurality of wireless communication channels.

Example 24 includes the subject matter of Example 23, and optionally, wherein a wireless communication channel of the plurality of wireless communication channels comprises a channel width of at least 20 Megahertz (MHz).

Example 25 includes the subject matter of any one of Examples 21-24, and optionally, wherein the plurality of wireless communication resources comprises a plurality of Orthogonal-Frequency-Division-Multiple-Access (OFDMA) Resource Units (RUs).

Example 26 includes the subject matter of any one of Examples 21-25, and optionally, wherein the plurality of wireless communication resources comprises a plurality of wireless communication links between the wireless communication device and the transmitter device.

Example 27 includes the subject matter of any one of Examples 21-26, and optionally, wherein the apparatus is configured to cause the wireless communication device to communicate setup information with the transmitter device prior to receiving the plurality of received packets, wherein the setup information comprises information to identify the plurality of wireless communication resources.

Example 28 includes the subject matter of any one of Examples 20-27, and optionally, wherein the apparatus is configured to cause the wireless communication device to identify a location of a received encoded packet in the n encoded packets based on a sequence number in the received encoded packet.

Example 29 includes the subject matter of any one of Examples 20-28, and optionally, wherein the NC scheme is configured such that the k data packets are decodable from any group of p encoded packets from the n encoded packets, wherein p is a predefined value equal to or greater than k.

Example 30 includes the subject matter of any one of Examples 20-29, and optionally, wherein the NC scheme is configured such that the k data packets are decodable from any group of k encoded packets from the n encoded packets.

Example 31 includes the subject matter of any one of Examples 20-30, and optionally, wherein the k data packets comprise time-sensitive data packets.

Example 32 includes the subject matter of any one of Examples 20-31, and optionally, wherein the wireless communication device comprises an Ultra-Low-Latency (ULL) STA.

Example 33 includes the subject matter of any one of Examples 20-32, and optionally, comprising a radio to receive the plurality of received packets.

Example 34 includes the subject matter of Example 33, and optionally, comprising one or more antennas connected to the radio, and a processor to execute instructions of an operating system of the wireless communication device.

Example 35 comprises a wireless communication device comprising the apparatus of any of Examples 1-34.

Example 36 comprises an apparatus comprising means for executing any of the described operations of any of Examples 1-34.

Example 37 comprises a product comprising one or more tangible computer-readable non-transitory storage media comprising computer-executable instructions operable to, when executed by at least one processor, enable the at least one processor to cause a wireless communication device to perform any of the described operations of any of Examples 1-34.

Example 38 comprises an apparatus comprising: a memory interface; and processing circuitry configured to: perform any of the described operations of any of Examples 1-34.

Example 39 comprises a method comprising any of the described operations of any of Examples 1-34.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication device to:
encode k data packets into n encoded packets according to a Network Coding (NC) scheme, wherein k is equal to or greater than two, and wherein n is greater than k, wherein the NC scheme is configured such that the k data packets are decodable from a group of at least k encoded packets; and
transmit the n encoded packets over a plurality of wireless communication resources by transmitting at least one first encoded packet over a first wireless communication resource and transmitting at least one second encoded packet over a second wireless communication resource.

2. The apparatus of claim 1 configured to cause the wireless communication device to avoid fully performing a Carrier Sense Multiple Access/Collision Avoidance (CSMA/CA) procedure prior to transmitting the n encoded packets over the plurality of wireless communication resources.

3. The apparatus of claim 2 configured to mandate the wireless communication device to fully perform the CSMA/CA procedure prior to transmitting one or more other data packets, which are not encoded according to the NC scheme, over one or more of the wireless communication resources.

4. The apparatus of claim 3, wherein the k data packets have a first latency requirement and the other data packets have a second latency requirement, the first latency requirement is lower than the second latency requirement.

5. The apparatus of claim 2 configured to cause the wireless communication device to avoid fully performing the CSMA/CA procedure by avoiding performance of a full Clear Channel Assessment (CCA) and backoff procedure prior to transmitting the n encoded packets over the plurality of wireless communication resources.

6. The apparatus of claim 2 configured to cause the wireless communication device to avoid fully performing the CSMA/CA procedure by avoiding performance of a virtual carrier sensing procedure prior to transmitting the n encoded packets over the plurality of wireless communication resources.

7. The apparatus of claim 1, wherein the plurality of wireless communication resources comprises a plurality of wireless communication frequency resources.

8. The apparatus of claim 1, wherein the plurality of wireless communication resources comprises a plurality of wireless communication channels.

9. The apparatus of claim 8, wherein a wireless communication channel of the plurality of wireless communication channels comprises a channel width of at least 20 Megahertz (MHz).

10. The apparatus of claim 1, wherein the plurality of wireless communication resources comprises a plurality of Orthogonal-Frequency-Division-Multiple-Access (OFDMA) Resource Units (RUs).

11. The apparatus of claim 1, wherein the plurality of wireless communication resources comprises a plurality of wireless communication links between the wireless communication device and a receiver device.

12. The apparatus of claim 1, wherein an encoded packet of the n encoded packets comprises a sequence number to indicate a location of the encoded packet in the n encoded packets.

13. The apparatus of claim 1, wherein the NC scheme is configured such that the k data packets are decodable from any group of p encoded packets from the n encoded packets, wherein p is a predefined value equal to or greater than k.

14. The apparatus of claim 1, wherein the k data packets comprise time-sensitive data packets.

15. The apparatus of claim 1 configured to cause the wireless communication device to communicate setup information with a receiver device prior to transmitting the n encoded packets to the receiver device, wherein the setup information comprises information to identify the plurality of wireless communication resources.

16. The apparatus of claim 1, wherein the wireless communication device comprises an Ultra-Low-Latency (ULL) STA.

17. The apparatus of claim 1 comprising a radio to transmit the n encoded packets.

18. The apparatus of claim 17 comprising one or more antennas connected to the radio, and a processor to execute instructions of an operating system of the wireless communication device.

19. A product comprising one or more tangible computer-readable non-transitory storage media comprising computer-executable instructions operable to, when executed by at least one processor, enable the at least one processor to cause a wireless communication device to:
encode k data packets into n encoded packets according to a Network Coding (NC) scheme, wherein k is equal to or greater than two, and wherein n is greater than k, wherein the NC scheme is configured such that the k data packets are decodable from a group of at least k encoded packets; and
transmit the n encoded packets over a plurality of wireless communication resources by transmitting at least one first encoded packet over a first wireless communication resource and transmitting at least one second encoded packet over a second wireless communication resource.

20. The product of claim 19, wherein the instructions, when executed, cause the wireless communication device to avoid fully performing a Carrier Sense Multiple Access/Collision Avoidance (CSMA/CA) procedure prior to transmitting the n encoded packets over the plurality of wireless communication resources.

21. An apparatus comprising logic and circuitry configured to cause a wireless communication device to:
process a plurality of received packets from a transmitter device, the plurality of received packets comprising at least k encoded packets out of n encoded packets, the n encoded packets encoding k data packets according to a Network Coding (NC) scheme, wherein k is equal to or greater than two, and wherein n is greater than k; and
determine the k data packets by decoding the at least k encoded packets according to the NC scheme.

22. The apparatus of claim 21 configured to cause the wireless communication device to listen over a plurality of wireless communication resources to receive the plurality of received packets.

23. The apparatus of claim 22 configured to cause the wireless communication device to communicate setup information with the transmitter device prior to receiving the plurality of received packets, wherein the setup information comprises information to identify the plurality of wireless communication resources.

24. An apparatus for a wireless communication device, the apparatus comprising:
means for processing a plurality of received packets from a transmitter device, the plurality of received packets comprising at least k encoded packets out of n encoded packets, the n encoded packets encoding k data packets according to a Network Coding (NC) scheme, wherein k is equal to or greater than two, and wherein n is greater than k; and
means for determining the k data packets by decoding the at least k encoded packets according to the NC scheme.

25. The apparatus of claim 24 comprising means for causing the wireless communication device to listen over a plurality of wireless communication resources to receive the plurality of received packets.
